(19) United States
(12) Patent Application Publication
(10) Pub. No.: US 2013/0019045 A1
(43) Pub. Date: Jan. 17, 2013

(54) Consolidating Computer Memory Drive Management In A Computing System

(71) Applicants: Mark E. Andresen, Cary, NC (US); Thomas H. Newsom, Cary, NC (US); Scott A. Nichols, Cary, NC (US)

(72) Inventors: Mark E. Andresen, Cary, NC (US); Thomas H. Newsom, Cary, NC (US); Scott A. Nichols, Cary, NC (US)

(73) Assignee: INTERNATIONAL BUSINESS MACHINES CORPORATION, ARMONK, NY (US)

(21) Appl. No.: 13/182,528

(22) Filed: Jul. 14, 2011

(51) Int. Cl. G06F 13/20

(52) U.S. Cl. 710/313

(57) ABSTRACT

Consolidating computer memory drive management in a computing system, the computing system including a plurality of computer memory drives, a system memory drive manager, and one or more light pipes, including: detecting, by a system memory drive manager, an multi-drive tray memory drive manager; configuring the system memory drive manager to communicate with the memory drive over the light pipe; and communicating, by the system memory drive manager, with the memory drive over the light pipe.

### BACKGROUND OF THE INVENTION

1. Field of the Invention

The field of the invention is data processing, or, more specifically, methods, apparatus, and products for consolidating computer memory drive management in a computing system.

2. Description of Related Art

Storage subsystems containing a large number of drives connected to a Serial Attached SCSI (‘SAS’) RAID controller require a SAS expander to access and manage the disks and associated controller hardware. This is done through an internal Storage Enclosure Processor (‘SEP’) using Storage Enclosure Services (‘SES’). The SEP provides the path from high speed SAS (in-band) to low speed General Purpose Input/Output (‘GPIO’) signals. Some of the GPIO signals are used to turn on Light Emitting Diodes (‘LEDs’) or detect the presence of a drive as part of these services. If all the drives are not attached directly to the primary expander, additional expanders must be added (cascaded) to the primary and its cascaded partners until all the remaining drives are connected to that expander chain. Each expander would provide its own SES device to drives that are connected to the expander. The initiator must now deal with multiple SEPs and multiple SES devices. If the number of SEPs and SES devices becomes extremely large this may require a lot of overhead in the initiator to manage this environment.

### SUMMARY OF THE INVENTION

Methods, apparatus, and products for consolidating computer memory drive management in a computing system, the computing system including a plurality of computer memory drives, a system memory drive manager, and one or more light pipes, including: detecting, by a system memory drive manager, an multi-drive tray memory drive manager; configuring the system memory drive manager to communicate with the memory drive over the light pipe; and communicating, by the system memory drive manager, with the memory drive over the light pipe.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for consolidating computer memory drive management according to embodiments of the present invention.

FIG. 2 sets forth a flow chart illustrating an exemplary method for consolidating computer memory drive management in a computing system according to embodiments of the present invention.

FIG. 3 sets forth a flow chart illustrating an exemplary method for consolidating computer memory drive management in a computing system according to embodiments of the present invention.

### DETAILED DESCRIPTION OF EXEMPLARY EMBODIMENTS

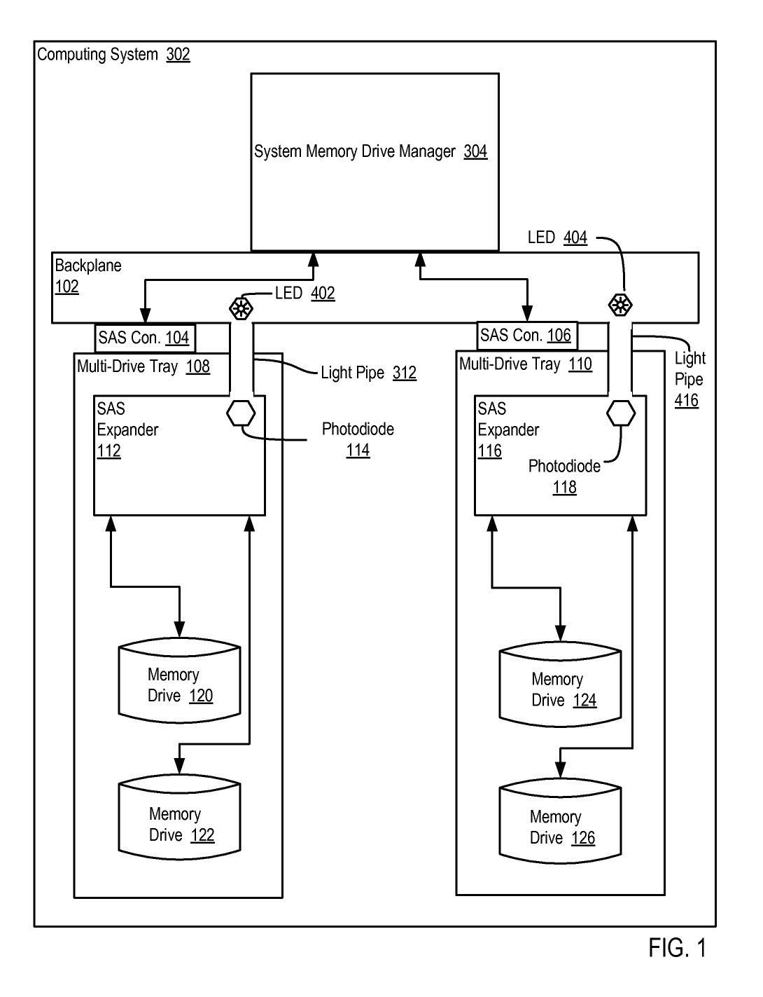

Exemplary methods, apparatus, and products for consolidating computer memory drive management in a computing system in accordance with the present invention are described with reference to the accompanying drawings, beginning with FIG. 1. FIG. 1 sets forth a block diagram of a system for consolidating computer memory drive management according to embodiments of the present invention. The computing system (302) of FIG. 1 includes a plurality of computer memory drives (120, 122, 124, 126), a system memory drive manager (304), and one or more light pipes (312, 416).

In the example of FIG. 1, the system memory drive manager (304) is a module of automated computing machinery that manages a group of memory drives (120, 122, 124, 126) and presents the group of memory drives (120, 122, 124, 126) as a one or more logical units. Examples of system memory drive manager (304) include a Serial Attached SCSI (‘SAS’) expander in a Redundant Array of Independent Disks (‘RAID’) controller or other disk array controller.

In the example of FIG. 1, the plurality of computer memory drives (120, 122, 124, 126) may be embodied, for example, as hard drives, optical drives, or other forms of non-volatile computer memory. Such memory drives (120, 122, 124, 126) may be accessible, for example, over a SAS bus, Serial ATA (‘SATA’) bus, and so on. Each memory drive (120, 122, 124, 126) is housed in a multi-drive tray (108, 110). In the example of FIG. 1, each multi-drive tray (108, 110) may be embodied as a disk enclosure configured to support multiple memory drives (120, 122, 124, 126) such as, for example, a SCSI drive tray, a SAS drive tray, a SATA drive tray, and so on. Each multi-drive tray (108, 110) can include a SAS expander (112, 118) or other module of automated computing machinery for providing a single connection point between the multiple memory drives (120, 122, 124, 126) housed by the multi-drive tray (108, 110) and other components of the computing system (302).

In the example of FIG. 1, the system memory drive manager (304) is coupled for data communications with the memory drives (120, 122, 124, 126) in the multi-drive trays (108, 110) via a SAS connector (104, 106) coupled to a backplane (102). In the example of FIG. 1, such SAS connectors (104, 106) may be embodied, for example, as standard SFF-8482 SAS connectors that are coupled to the backplane (102). In the example of FIG. 1, the backplane (102) includes a group of connectors connected in parallel so that each pin of each connector is linked to the same relative pin of all the other connectors forming a computer bus. The backplane (102) of FIG. 1 can be used to couple the system memory drive manager (304) to the SAS connectors (104, 106) that are coupled to the multi-drive trays (108, 110).

In the example of FIG. 1, the system memory drive manager (304) is also coupled for data communications with the memory drives (120, 122, 124, 126) in the multi-drive trays (108, 110) via a SAS connector (104, 106) through the use of one or more light pipes (312, 416). In the example of FIG. 1, the one or more light pipes (312, 416) may be embodied as any physical enclosure through which light may be carried. In the example of FIG. 1, the light pipes (312, 416) may be used to carry light from an illumination source, such as an LED (402, 404), to an illumination sensor, such as a photodiode (114, 118).

In the example of FIG. 1, the computing system (302) can carry out consolidating computer memory drive management by detecting, by a system memory drive manager (304), a multi-drive tray memory drive manager such as the SAS expanders (112, 116). The computing system (302) can further carry out consolidating computer memory drive management by configuring the system memory drive manager (304) to communicate with a memory drive (120, 122, 124, 126) over a light pipe (312, 416) and communicating, by the system memory drive manager (304), with the memory drive over the light pipe (120, 122, 124, 126). In the example of FIG. 1, communicating, by the system memory drive manager (304), with a memory drive (120, 122, 124, 126) over a light pipe (312, 416) can include pulsing the LED (402, 404) in a predetermined pattern. The predetermined pattern may represent digital information such that the system memory drive manager (304) can pass digital information to a memory drive (120, 122, 124, 126)) via a light pipe (312, 418). For example, an illuminated LED (402, 404) may be analogous to a digital ‘1’ while an unilluminated LED (402, 404) may be analogous to a digital ‘0’. As such, each photodiode (114, 118) may be used to sample the LED (402, 404) at predetermined intervals of time to extract digital information from the illumination pattern of the LED (402, 404). For example, an illumination pattern of ‘off, off, on, off’ may represent a digital value of ‘0010,’ thereby enabling the exchange of information using the light pipes (312, 416) rather than the electrical connections provided by the backplane (102) and SAS connectors (104, 106).

Although not expressly illustrated in FIG. 1, the computing system (302) may include a plurality of computing devices such as computer processors, computer memory, computer buses, data communications adapters, and so on.

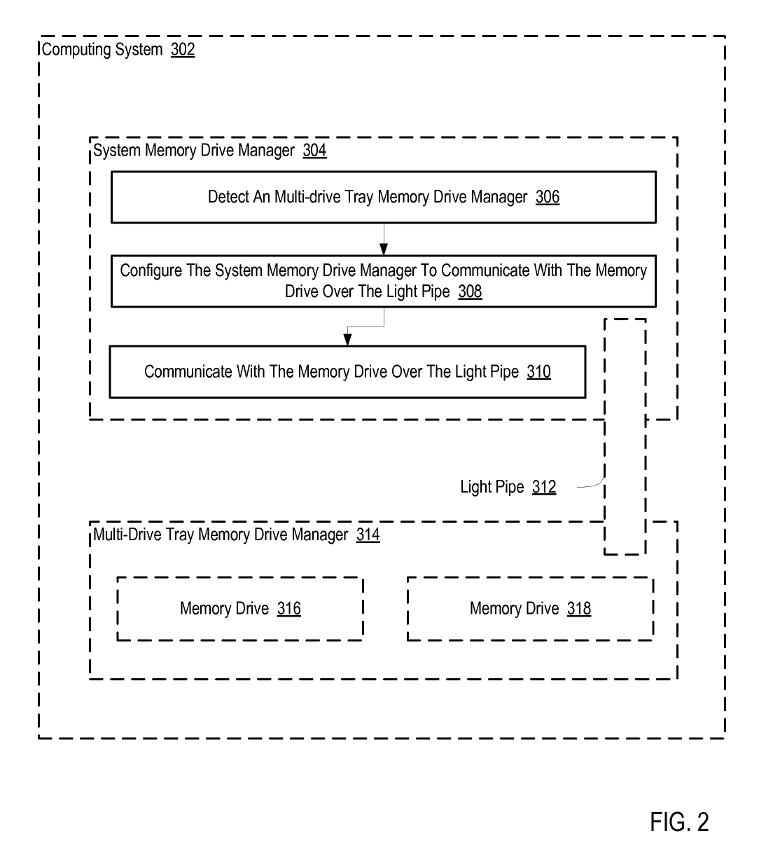

For further explanation, FIG. 2 sets forth a flow chart illustrating an exemplary method for consolidating computer memory drive management in a computing system (302) according to embodiments of the present invention. The computing system (302) of FIG. 2 includes a plurality of computer memory drives (316, 318). In the example of FIG. 2, the memory drives (316, 318) may be embodied, for example, as hard drives, optical drives, or other forms of non-volatile computer memory. Such memory drives (316, 318) may be accessible, for example, over a SAS bus, SATA bus, and so on.

The computing system (302) of FIG. 2 also includes a system memory drive manager (304). In the example of FIG. 2, the system memory drive manager (304) is a module of automated computing machinery that manages a group of memory drives (316, 318) and presents the group of memory drives (316, 318) as a one or more logical units. Examples of system memory drive manager (304) include a SAS expander in a RAID controller or other disk array controller.

The computing system (302) of FIG. 2 also includes one or more light pipes (312). In the example of FIG. 2, the one or more light pipes (312) may be embodied as any physical enclosure through which light may be carried. In the example of FIG. 2, the light pipes (312) may be used to carry light from an illumination source, such as an LED, to an illumination sensor, such as a photodiode.

The example method of FIG. 2 includes detecting (306), by a system memory drive manager (304), an multi-drive tray memory drive manager (314). In the example of FIG. 2, the multi-drive tray memory drive manager (314) may be a component in a disk enclosure configured to support multiple memory drives (316, 318) such as, for example, a SCSI drive tray, a SAS drive tray, a SATA drive tray, and so on. In the example of FIG. 2, the multi-drive tray memory drive manager (314) may be embodied, for example, as a SAS expander or other module of automated computing machinery for providing a single connection point between the multiple memory drives (316, 318) housed by the multi-drive tray and other components of the computing system.

In the example of FIG. 2, detecting (306), by a system memory drive manager (304), an multi-drive tray memory drive manager (314) may be carried out, for example, through data communications between the system memory drive manager (304) and the multi-drive tray memory drive manager (314). For example, the multi-drive tray memory drive manager (314) may broadcast its presence using presence detection signal line, the system memory drive manager (304) may poll a backplane to identify all multi-drive trays connected to the backplane, and so on.

The example method of FIG. 2 also includes configuring (308) the system memory drive manager (304) to communicate with the memory drive over the light pipe (312). In the example of FIG. 2, the system memory drive manager (304) may have multiple communications paths through which the system memory drive manager (304) can communicate with the memory drives (316, 318). For example, the system memory drive manager (304) may communicate with the memory drives (316, 318) via a backplane that couples the system memory drive manager (304) and the multi-drive tray memory manager (314) for data communications. The system memory drive manager (304) and the multi-drive tray memory manager (314) may also be coupled for data communications, according to embodiments of the present invention, via the light pipe (312). Configuring (308) the system memory drive manager (304) to communicate with the memory drive over the light pipe (312) may therefore be carried out, for example, by associating a particular memory drive with a particular communications path. For example, an identifier for memory drive (316) may be associated with communications path provided by a backplane, while an identifier for memory drive (318) may be associated with communications path provided by the light pipe (312), such that the system memory drive manager (304) is configured to communicate with memory drive (316) via the backplane and the system memory drive manager (304) is configured to communicate with memory drive (318) via the light pipe (318).

The example method of FIG. 2 also includes communicating (310), by the system memory drive manager (304), with the memory drive (318) over the light pipe (312). In the example of FIG. 2, communicating (310) with the memory drive (318) over the light pipe (312) may be carried out, for example, through optical communications in which a light source controlled by the system memory drive manager (304) is used to send a series of light pulses that represent digital information over the light pipe (312). In the example of FIG. 2, the light source may be embodied as an infrared laser, LED, or other light source. In the example of FIG. 2, an infrared sensor, photodiode, or other light sensor may be used by the multi-drive tray memory drive manager (314) to sense the signal emitted from the light source and convert the signal into a digital signal that is ultimately passed to the memory drive (318) as digital information.

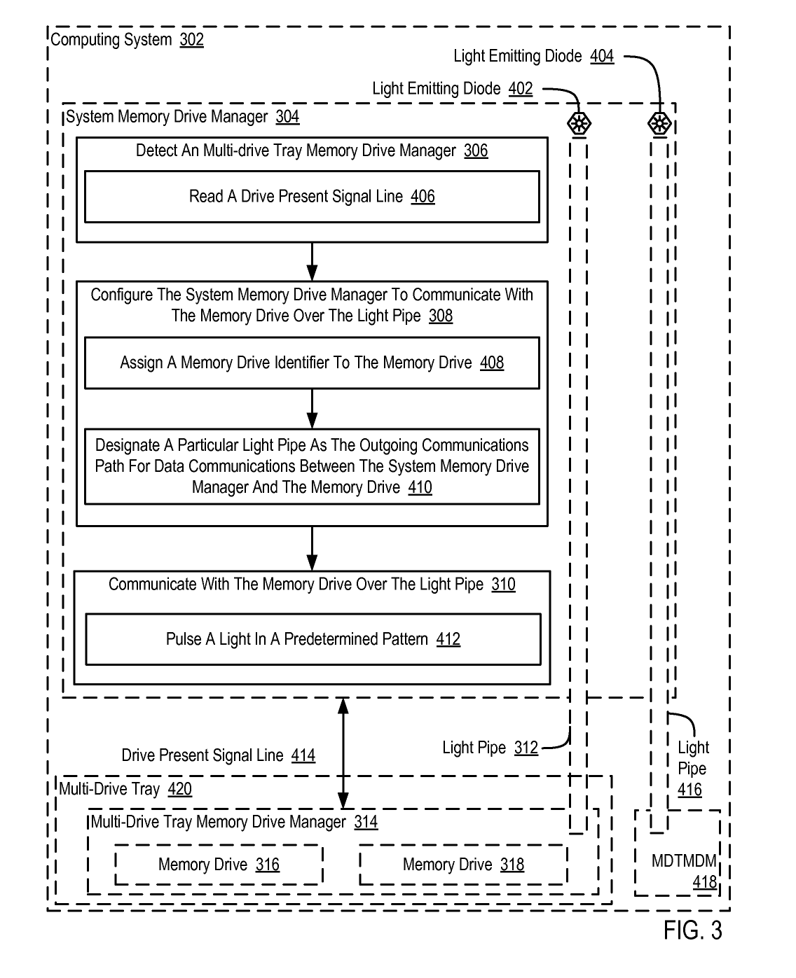

For further explanation, FIG. 3 sets forth a flow chart illustrating a further example method for consolidating computer memory drive management in a computing system (302) according to embodiments of the present invention. The example method of FIG. 3 is similar to the example method of FIG. 2 as it also includes detecting (306), by a system memory drive manager (314), an multi-drive tray memory drive manager (314); configuring (308) the system memory drive manager (304) to communicate with the memory drive over the light pipe (312); and communicating (310), by the system memory drive manager (304), with the memory drive over the light pipe (312).

In the example of FIG. 3, however, detecting (306), by a system memory drive manager (314), an multi-drive tray memory drive manager (314) may include reading (406) a drive present signal line (414). In the example of FIG. 3, the drive present signal line (414) is a signal line between the system memory drive manager (304) and a multi-drive tray memory drive manager (314) for signaling to the system memory drive manager (304) that one or more memory drives are inserted into a multi-drive tray (420) whose memory drives are managed by the multi-drive tray memory drive manager (314). The system memory drive manager (314) may detect the presence of a memory drive that is inserted into the multi-drive tray (420), for example, by polling the multi-drive tray memory drive manager (314) over the drive present signal line (414) at predetermined intervals, by receiving a signal from the multi-drive tray memory drive manager (314) over the drive present signal line (414) when a memory drive is inserted into the multi-drive tray (420), and so on.

In the example of FIG. 3, configuring (308) the system memory drive manager (304) to communicate with the memory drive over the light pipe (312) can include assigning (406), by the system memory drive manager (304), a memory drive identifier to the memory drive. In such an example, configuring (308) the system memory drive manager (304) to communicate with the memory drive over the light pipe (312) can also include designating (410), by the system memory drive manager (304), a particular light pipe (312, 416) as the outgoing communications path for data communications between the system memory drive manager (304) and the memory drive.

In the example of FIG. 3, the system memory drive manager (304) may have multiple communications paths through which the system memory drive manager (304) can communicate with the memory drives (316, 318). For example, the system memory drive manager (304) may communicate with the memory drives (316, 318) via a backplane that couples the system memory drive manager (304) and the multi-drive tray memory manager (314) for data communications. The system memory drive manager (304) and the multi-drive tray memory manager (314) may also be coupled for data communications, according to embodiments of the present invention, via the light pipe (312). Configuring (308) the system memory drive manager (304) to communicate with the memory drive over the light pipe (312) may therefore be carried out, for example, by associating a particular memory drive with a particular communications path. For example, an identifier for memory drive (316) may be associated with communications path provided by a backplane, while an identifier for memory drive (318) may be associated with communications path provided by the light pipe (312), such that the system memory drive manager (304) is configured to communicate with memory drive (316) via the backplane and the system memory drive manager (304) is configured to communicate with memory drive (318) via the light pipe (318).

In the example of FIG. 3, each light pipe (312, 416) includes a status light-emitting diode (LED') (402, 404). In the example of FIG. 3, the status LED (402, 404) is a light source that, in typical operation, is illuminate to show the status of a particular hard drive in a drive tray. For example, if the status LED (402, 404) is illuminated, this is typically an indication that a hard drive is installed in a particular drive tray. If the status LED (402, 404) is not illuminated, however, this is typically an indication that a hard drive is either not installed in a particular drive tray or inoperable. Although the status LED (402, 404) is typically used to show the status of a particular hard drive in a drive tray, in the example of FIG. 3, the status LED (402, 404) is a light source that is used to carry out data communications between the system memory drive manager (304) and the multi-drive tray manager (314).

In the example of FIG. 3, communicating (310), by the system memory drive manager (304), with the memory drive over the light pipe (312) can include pulsing (412) a light in a predetermined pattern. In the example of FIG. 3, pulsing (412) a light in a predetermined pattern may be carried out, for example, by pulsing the status LED (402, 404) in a predetermined pattern. The predetermined pattern may represent digital information such that the system memory drive manager (304) can pass digital information to a memory drive (316, 318) via a light pipe (312, 418). For example, an illuminated status LED (402, 404) may be analogous to a digital ‘1’ while an unilluminated status LED (402, 404) may be analogous to a digital ‘0’. As such, by sampling the status LED (402, 404) at predetermined intervals of time, digital information can be extracted from the illumination pattern of the status LED (402, 404).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of consolidating computer memory drive management in a computing system, the computing system including a plurality of computer memory drives, a system memory drive manager, and one or more light pipes, the method comprising:
detecting, by a system memory drive manager, an multi-drive tray memory drive manager;
configuring the system memory drive manager to communicate with the memory drive over the light pipe; and
communicating, by the system memory drive manager, with the memory drive over the light pipe.

2. The method of claim 1 wherein detecting the multi-drive tray memory drive manager further comprises reading a drive present signal line.

3. The method of claim 1 wherein configuring the system memory drive manager to communicate with the memory drive over the light pipe further comprises:
assigning, by the system memory drive manager, a memory drive identifier to the memory drive; and
designating, by the system memory drive manager, a particular light pipe as the outgoing communications path for data communications between the system memory drive manager and the memory drive.

4. The method of claim 1 wherein the light pipe includes a status light-emitting diode (‘LED’).

5. The method of claim 1 wherein communicating, by the system memory drive manager, with the memory drive over the light pipe includes pulsing a light in a predetermined pattern.

6. The method of claim 1 wherein the system memory drive manager is a Serial Attached SCSI (‘SAS’) expander in a Redundant Array of Independent Disk (‘RAID’) controller, wherein the SAS expander is coupled to one or more disk drive trays via a backplane.

7. Apparatus for consolidating computer memory drive management in a computing system, the apparatus comprising a computer processor, a computer memory operatively coupled to the computer processor, the computer memory having disposed within it computer program instructions that, when executed by the computer processor, cause the apparatus to carry out the steps of:
detecting, by a system memory drive manager, an multi-drive tray memory drive manager;
configuring the system memory drive manager to communicate with the memory drive over the light pipe; and
communicating, by the system memory drive manager, with the memory drive over the light pipe.

8. The apparatus of claim 7 wherein detecting the multi-drive tray memory drive manager further comprises reading a drive present signal line.

9. The apparatus of claim 7 wherein configuring the system memory drive manager to communicate with the memory drive over the light pipe further comprises:
assigning, by the system memory drive manager, a memory drive identifier to the memory drive; and
designating, by the system memory drive manager, a particular light pipe as the outgoing communications path for data communications between the system memory drive manager and the memory drive.

10. The apparatus of claim 7 wherein the light pipe includes a status light-emitting diode (LED).

11. The apparatus of claim 7 wherein communicating, by the system memory drive manager, with the memory drive over the light pipe includes pulsing a light in a predetermined pattern.

12. The apparatus of claim 7 wherein the system memory drive manager is a Serial Attached SCSI (‘SAS’) expander in a Redundant Array of Independent Disk (‘RAID’) controller, wherein the SAS expander is coupled to one or more disk drive trays via a backplane.

13. A computer program product for computer memory drive management in a computing system, the computer program product disposed upon a computer readable storage medium, the computer program product comprising computer program instructions that, when executed, cause a computer to carry out the steps of:
detecting, by a system memory drive manager, an multi-drive tray memory drive manager;
configuring the system memory drive manager to communicate with the memory drive over the light pipe; and
communicating, by the system memory drive manager, with the memory drive over the light pipe.

14. The computer program product of claim 13 wherein detecting the multi-drive tray memory drive manager further comprises reading a drive present signal line.

15. The computer program product of claim 13 wherein configuring the system memory drive manager to communicate with the memory drive over the light pipe further comprises:
assigning, by the system memory drive manager, a memory drive identifier to the memory drive; and
designating, by the system memory drive manager, a particular light pipe as the outgoing communications path for data communications between the system memory drive manager and the memory drive.

16. The computer program product of claim 13 wherein the light pipe includes a status light-emitting diode (‘LED’).

17. The computer program product of claim 13 wherein communicating, by the system memory drive manager, with the memory drive over the light pipe includes pulsing a light in a predetermined pattern.

18. The computer program product of claim 13 wherein the system memory drive manager is a Serial Attached SCSI (‘SAS’) expander in a Redundant Array of Independent Disk (‘RAID’) controller, wherein the SAS expander is coupled to one or more disk drive trays via a backplane.
